(19) United States
(12) Patent Application Publication
(10) Pub. No.: US 2006/0190359 A1
(43) Pub. Date: Aug. 24, 2006

(54) Consignment inventory management and reconciliation system

(76) Inventors: James Barwick, SUWANEE, GA (US); Joel Haspel, Singapore (SG)

Correspondence Address: Blakely Sokoloff;Taylor & Zafman, 7th Floor, 12400 Wilshire Boulevard, Los Angeles, CA, 90025, US

(21) Appl. No.: 10/549,990

(22) PCT Filed: Feb. 3, 2004
(86) PCT No.: PCT/SG04/00032

§ 371 Date: Sep. 15, 2005

Related U.S. Application Data
(63) Continuation of application No. 10/394,837, filed on Mar. 21, 2003.

(51) Int. Cl. G07F 7/00

(52) U.S. Cl. 705/28

(57) ABSTRACT

A consignment inventory management and reconciliation method and system that tracks and reconciles on-hand quality which represents consignment items that were placed at the consignment location and are physically located at the consignment location at a given time; unbilled quantity which represents consignment items which were placed at the consignment location and are not physically present at the consignment location and have not been purchased at a given time, excess quantity which represents items found at the consignment location but are not considered consignment items at a given time; and perpetual quantity which represents the consignment items which have been delivered to the consignment location at a given time.

### FIELD OF INVENTION

The present invention relates to a consignment inventory management and reconciliation system and preferably, though not exclusively, than can track and age all relevant items in a consignment Inventory.

### BACKGROUND TO THE INVENTION AND DEFINITIONS

In July 1998 the Electronics Industry Data Exchange (EIDX) published a paper entitled “Inventory Management Business Models for Consignment Processes”. In that paper was a definition of consigned inventory:

Consigned inventory is inventory that is in the possession of one party (for example, customer, dealer, agent, and so forth), but remains the property of another party (for example, manufacturer, prime contractor, and so forth) by mutual agreement.

The possessor of the inventory does not hold title to the inventory. Liability for the inventory is per contractual agreement. Title may or may not pass to the possessor depending on the contractual agreement.

Title may pass from a seller to a buyer when the buyer consumes the inventory.

Inventory may be consigned by a buyer to a third-party warehouse, to whom liability may pass but not title.

Inventory may be consigned by a buyer to a contract manufacturer; title may or may not transfer depending on the contractual agreement;

It has the synonyms:
Supplier-owned inventory (from the buyers perspective)
Customer-owned inventory (from the contract manufacturer's perspective)
In-house stores (from consignee's perspective)
Line-side stocking
Remote warehouse (from sellers perspective)

That definition applies throughout this specification.

Inventory item tracking systems are widely used for the tracking and management of items in a warehouse or retail location.

Current consignment inventory methods and systems only track the amount of consignment inventory that has been shipped to the buyer's consignment location by the seller. This is traditionally referred to as the on-hand quantity. Current consignment inventory systems will increment the on-hand quantity when items are shipped to the buyer and decrement the on-hand quantity when ownership is transferred from the seller to the buyer; the buyer returns the item to the seller; the item is determined to be missing and seller writes-off the item.

Currently there are no methods or systems to track and age items that:
were shipped from the seller to the buyer;
have not been billed by the seller; and
cannot be found at the buyer's consignment location.

This is identified as the Unbilled quantity in this specification.

Currently there are no methods and systems to track and age items that:
were not shipped to the buyer from the seller
can be found at the buyer's consignment location and are the same as items provided by the seller to the buyer on consignment

This is identified as the Excess quantity in this specification.

Consignment inventory management methods and processes today rely on the transfer of ownership for an item between the buyer and seller in order for consigned inventory to be reduced. The current methods and systems do not allow for the tracking of items that have been shipped from the seller to the buyer and used by the buyer or removed from the buyer's consignment location with out notification to the seller.

### SUMMARY OF THE INVENTION

In one preferred aspect the present Invention provides a consignment inventory management and reconciliation system wherein there is tracking and reconciliation of:
a. first items shipped to a buyer from a seller and that are located at the buyer's consignment inventory location;
b. second items shipped to the buyer by the seller, that have not been billed by the seller and cannot be found at the buyer's consignment inventory location; and
c. third items not shipped to the buyer by the seller, can be found at the buyer's consignment inventory location, and are of the same identity as items provided on consignment by the seller to the buyer

Preferably, the system, also ages the first items and the second items;

There may be tracking of one or more selected from the groups consisting of: item number, item lot number, and item expiry date. Tracking may take place whenever a transaction is processed. A transaction may be represented by a transaction description and a transaction amount. The transaction amount may be zero, a positive number, and a negative number, with a number of decimal places. The transaction may be one or more of: bill, use, dispose, return, transfer-out, receive, transfer-in, order, set, and count.

Bill may be used when the item is no longer at the buyer's consignment location but ownership has to been transferred from the seller to the buyer.

Use may be used when the buyer has used the item and the process of transferring ownership from the seller to the buyer should be initiated or has been competed.

Dispose may be used when the item is no longer at the buyer's consignment location and seller is writing off the item. Ownership will not be transferred from the seller to the buyer.

Receive may be used when the item is physically being moved from the seller to the buyer's consignment location. Ownership will not be transferred from the seller to the buyer.

Transfer-in is used when the item is physically being moved to the buyer's consignment location from a third party location. Ownership will not be transferred from the seller to the buyer.

Return may be used when item is physically being moved from the buyer's consignment location back to the seller. Ownership will not be transferred from the seller to the buyer.

Transfer-out is used when the item is physically being moved from the buyer's consignment location to a third party location. Ownership will not be transferred from the seller to the buyer.

Order may be used when a request has been made to increase the buyer's consignment item(s) quantity.

Set may be used when the quantity of items that the seller and the buyer agree is at the consignment location. Can be used as a starting point for consignment inventory On-hand quantity.

Count may be used when the quantity can be physically found and verified by the seller and buyer at the buyer's consignment location at a time.

Preferably, reconciliation takes place after a stock count process. Reconciliation may note the first items as Unbilled and the third items as Excess to enable the seller to track quantities of first items and third items over time to provide a more accurate history of consignment inventory.

The seller may use the tracking of the item lot number and item expiry date to determine which of the first, second and third items are approaching an expiry date and thus need to be adjusted. Adjustment may be based on a reconciliation between what is counted (i.e. what is actually there) and what was thought to be there because it was shipped there.

One or more of the first, second and third items may be grouped together in a plurality of categories. Adjustment may be according to one or more of the plurality of categories.

An inventory total may be determined as being the sum of the first items and the second items, less the third items.

In a further form, there is provided a consignment inventory management and reconciliation system wherein there is tracking and reconciliation of first items shipped to a buyer from a seller and that are located at the buyer's consignment inventory location; and second items shipped to the buyer by the seller, that have not been billed by the seller and cannot be found at the buyer's consignment inventory location.

There may also be tracking of third items not shipped to the buyer by the seller, that can be found at the buyer's consignment inventory location, and are of the same identity as items provided on consignment by the seller to the buyer.

In yet another form there is provided a consignment inventory management and reconciliation system wherein there is tracking and reconciliation of first items shipped to a buyer from a seller and that are located at the buyer's consignment inventory location; and third items not shipped to the buyer by the seller, that can be found at the buyer's consignment inventory location, and are of the same identity as items provided on consignment by the seller to the buyer.

There may also be tracking and reconciliation of second items shipped to the buyer by the seller, that have not been billed by the seller and cannot be found at the buyer's consignment inventory location.

Finally, there may be provided a consignment inventory management and reconciliation system wherein there is tracking and reconciliation of second items shipped to the buyer by the seller, that have not been billed by the seller and cannot be found at the buyer's consignment inventory location; and third items not shipped to the buyer by the seller, can be found at the buyer's consignment inventory location, and are of the same identity as items provided on consignment by the seller to the buyer.

The present invention also extends to a computer useable medium having a computer program code that is configured to cause a processor to execute one or more functions to perform the process steps described above.

### DESCRIPTION OF THE DRAWINGS

In order for the present invention to be readily understood and put into practical effect there shall now be described by way of non-limitative example only preferred embodiments of the present invention, the description being with reference to the accompanying illustrative drawings, in which:

FIG. 1 is a flow chart of an overview of a consignment inventory management process according to a preferred form of the present invention;

FIG. 2 is a flow chart of the update consignment inventory process of FIG. 1;

FIG. 3 is a flow chart of purchase order process of FIG. 1;

FIG. 4 is a flow chart of restock process of FIG. 1;

FIG. 5 is a flow chart of billing process of FIG. 1;

FIG. 6 is a flow chart of stock count process of FIG. 1;

FIG. 7 is a flow chart of the return process of FIG. 1;

FIG. 8 is a flow chart of reconciliation process of FIG. 1;

FIG. 9 is a flow chart of adjust excess & unbilled process of FIG. 1; and

FIG. 10 is a flow chart of order picking process of FIG. 1.

### DESCRIPTION OF PREFERRED EMBODIMENTS

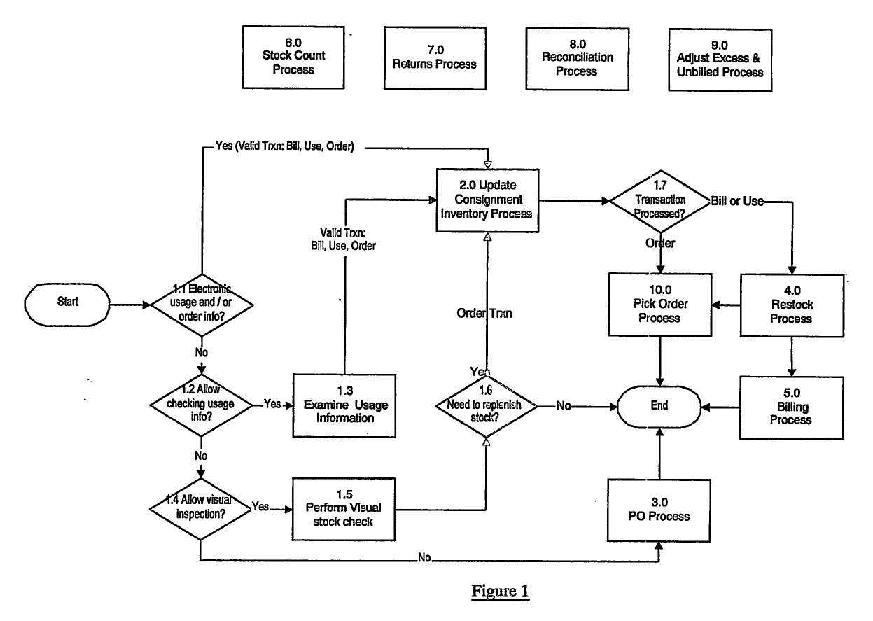

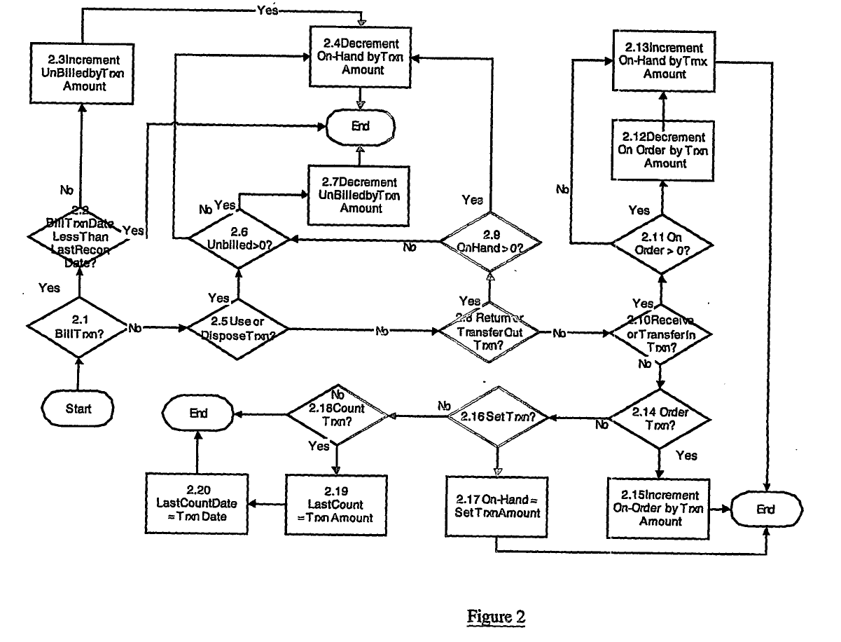

To first refer to FIG. 1, there is shown an overview of the overall process. Reference numbers starting with 2, 3, 4, 5, 6, 7, 8, 9 and 10 are for processes illustrated in FIGS. 2, 3, 4, 5, 6, 7, 8, 9 and 10 respectively.

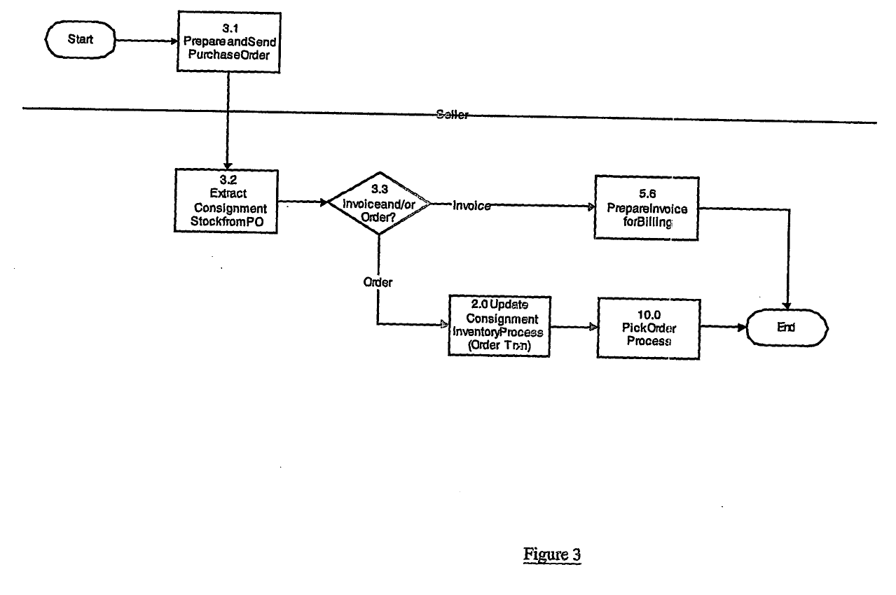

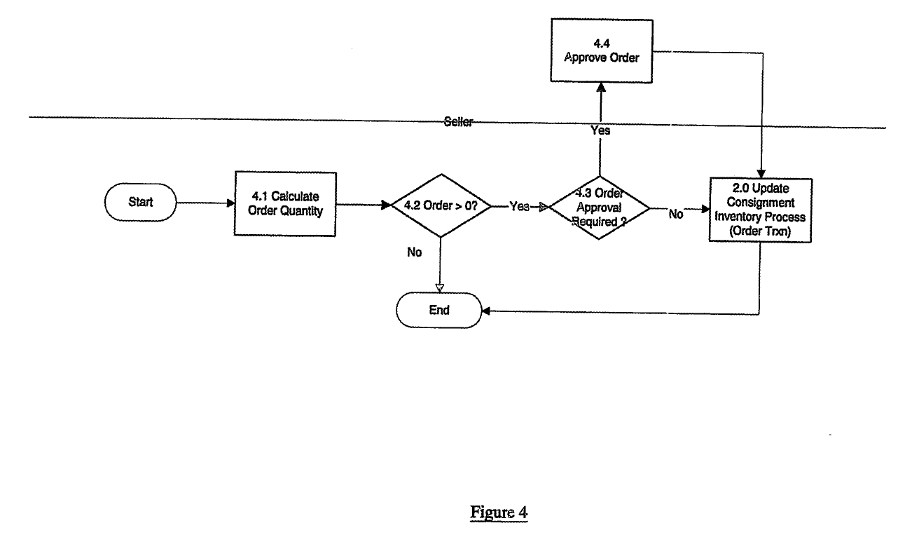

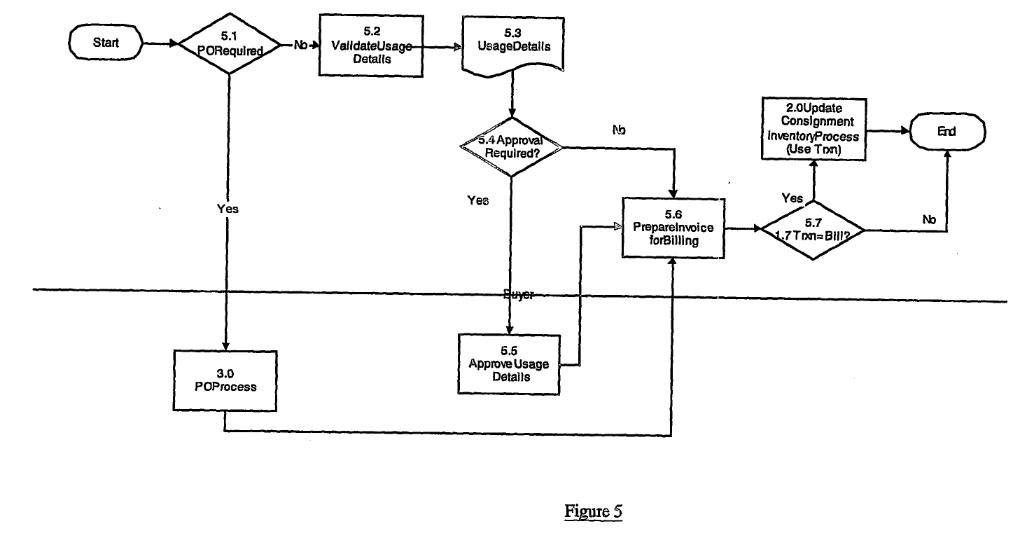

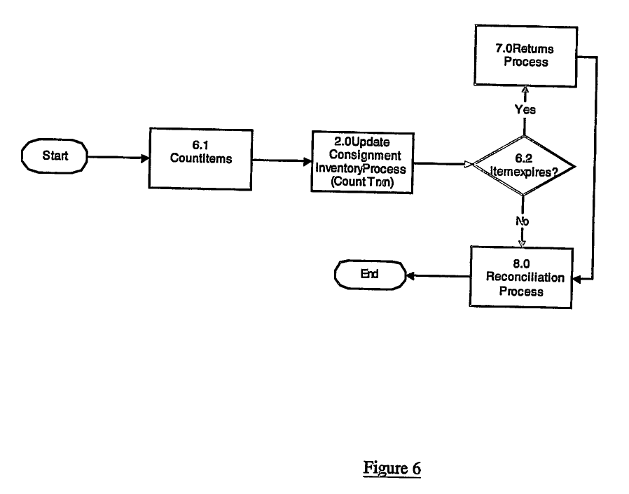

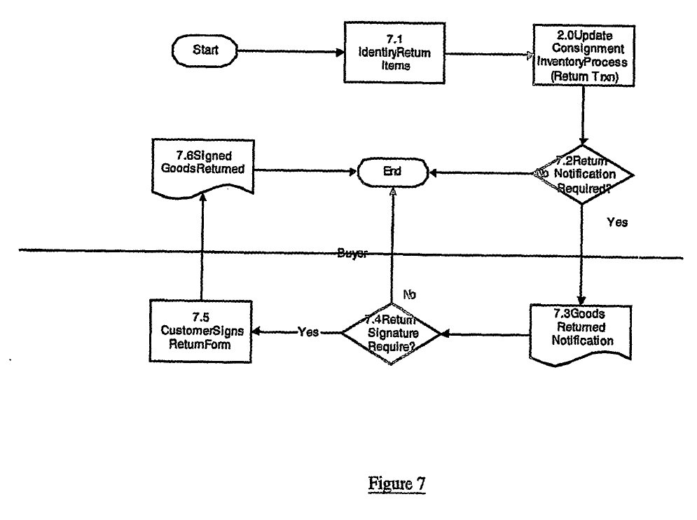

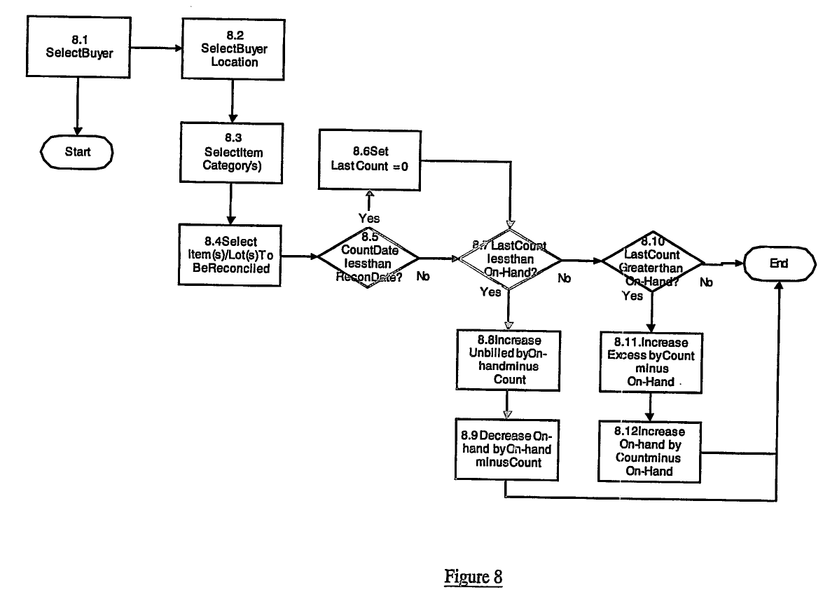

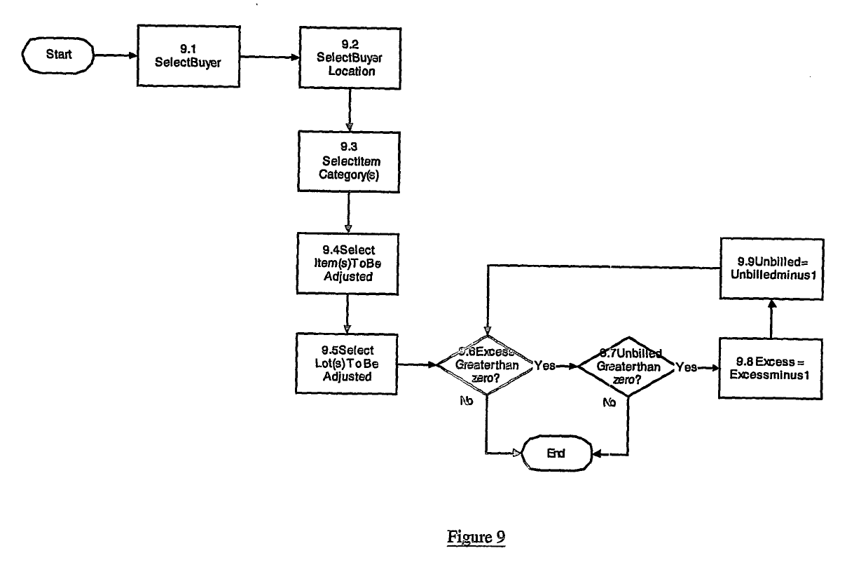

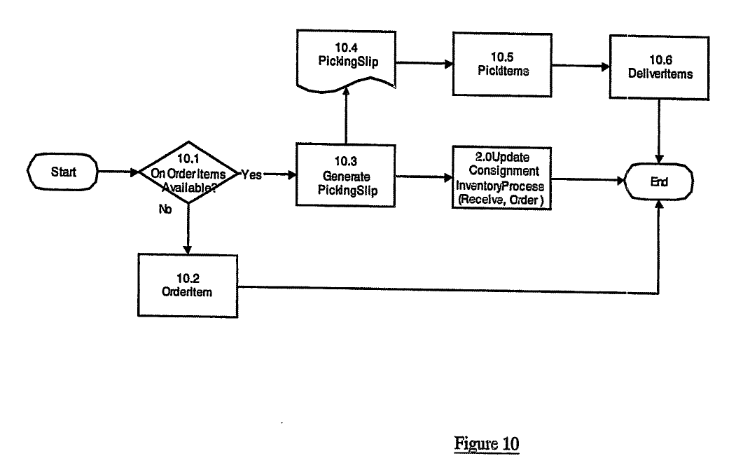

The consignment inventory management process may be initiated by many different events Including but not limited to item usage, order, and count. There are several ways the seller can be made aware of these events. FIG. 1 identifies these events. It also identifies all the other processes that impact on the several processes. In the first table is described the various elements and the process of FIG. 1.

| No. | Business Process | Process Description |
|---|---|---|
| 1.1 | Electronic Usage and or Order | Does the seller provide the buyer with electronic |
| | Information | usage/order information? |
| | | If Yes then go to 2.0 (Valid Transactions are Bill, |
| | | Use, Order) - see FIG. 2 and its description below. |
| | | If No then go to 1.2 |
| | | EDI and XML are examples of electronic formats that |
| | | the buyer can send item use and order information to |
| | | the seller: |

| | |
|---|---|
| a. | Electronic Data Exchange (EDI) that works by |
| | providing a collection of standard message |
| | formats and element dictionary in a simple way |
| | for businesses to exchange data via any |
| | electronic system; and |
| b. | eXtensible Markup Language (XML) is a |
| | simplified subset of the Standard Generalised |
| | Markup Language (SGML, ISO 8879) that |
| | provides a file format for representing data, a |
| | schema for describing data structure, and a |
| | mechanism for extending and annotating HTML |
| | with semantic information. |

| | | |
|---|---|---|
| 1.2 | Allow Checking of Usage | Does the buyer allow usage checking? |
| | Information | If Yes then go to 1.3 |
| | | If No then go to 1.4 |
| 1.3 | Examine Usage Information | The buyer provides the seller with an electronic or |
| | | written paper usage log/report, or the buyer may |
| | | allow the seller to review an internal usage log/report, |
| | | so that they may copy the usage information. |
| 1.4 | Allow Visual Inspection | Does the buyer allow the seller to physically inspect |
| | | the items? |
| | | If Yes then go to 2.0 (Valid Transactions are Bill, |
| | | Use, Order) - see FIG. 2 and its description below |
| | | If No then go to 1.5 |
| 1.5 | Perform Visual Stock Check | The seller physically view/inspect the consignment |
| | | inventory and determine if more items need to be |
| | | ordered for placement at the buyer's consignment |
| | | location. |
| 1.6 | Need to replenish Stock? | Does the seller believe that more items are required |
| | | at the buyer's consignment inventory location? |
| | | If Yes then go to 2.0 (Valid Transaction: Order) |
| | | If No then go to END |
| 2.0 | Update Consignment Inventory | Go To 2.0 - see FIG. 2 and its description below |
| | Process | |
| 1.7 | Transaction Processed? | If Bill or Order Transaction then go to 5.0 Billing - |
| | | see FIG. 5 and its description |
| | | If Order Transaction then go to 4.0 Restock Process - |
| | | see FIG. 4 and its description |
| 3.0 | Purchase Order Process | Go to 3.0 - see FIG. 3 and its description |
| 4.0 | Restock Process | Go to 4.0 - see FIG. 4 and its description |
| 5.0 | Billing Process | Go to 5.0 - see FIG. 5 and its description |
| 6.0 | Stock Count | Go to 6.0 - see FIG. 6 and its description |
| 7.0 | Returns Process | Go to 7.0 - see FIG. 7 and its description |
| 8.0 | Reconciliation Process | Go to 8.0 - see FIG. 8 and its description |
| 9.0 | Adjust Excess & Unbilled | Go to 9.0 - see FIG. 9 and its description |
| | Process | |
| 10.0 | Pick Order Process | Go to 10.0 - see FIG. 10 and its description |

To now refer to FIG. 2 items that were shipped to the buyer from the seller and are physically located at the buyer's consignment inventory located at a time are identified as the On-hand quantity.

Accounting methods and systems required the seller to keep track of the total consignment items shipped to the buyer and that should be at any time. This is called the Total quantity.
Total=On-hand+Unbilled−Excess

Like current consignment inventory methods and systems, On-Order represents consignment items that have been requested for the buyer's consignment location but have not been shipped at a time from the seller to the buyer.

A transaction is represented by a transaction description and a transaction amount. A transaction description is a code used to identify the transaction. It may be alpha, numeric or alphanumeric. The code may be of any suitable or desired length. The transaction amount can be a: zero, positive, or negative number with any number of decimal places.

Transactions (Trxn) used by this method and system include:
Bill: the item is no longer at the buyer's consignment location but ownership has to been transferred from the seller to the buyer.
Use: the buyer has used the item and the process of transferring ownership from the seller to the buyer should be initiated or has been competed.
Dispose: the item is no longer at the buyers consignment location and seller is writing off the item. Ownership will not be transferred from the seller to the buyer.
Return: item is physically being moved from the buyers consignment location back to the seller, ownership will not be transferred from the seller to the buyer.
Transfer-Out: item is physically being moved from the buyers consignment location to the a third party location, ownership will not be transferred from the seller to the buyer.
Receive: Item is physically being moved from the seller to the buyer's consignment location. Ownership will not be transferred from the seller to the buyer.
Transfer-In: item is physically being moved to the buyer's consignment location from a third party location. Ownership will not be transferred from the seller to the buyer.
Order: a result has been made to increase the buyer's consignment item(s) quantity.
Set: the quantity of items that the seller and the buyer agree is at the consignment location.

Can be used as a starting point for consignment Inventory On-hand quantity.
Count: the quantity that can be physically found and verified by the seller and buyer at the buyer's consignment location at a time.

The method and system tracks item number, item lot number and item expirations date. The transactions are processed for the item or item/lot numbers based on the transaction being passed into the Update Consignment Inventory Process. In most cases there is more than one possible transaction that can be processed. Which transaction is process is determined by:
the agreement between the buyer and seller; and
other systems and methods used by the buyer and seller.

While the transactions processed may vary depending on the buyer and seller the desired result is the same. A consignment inventory management and reconciliation method and system that tracks and reconciles Total, on-hand, unbilled and excess quantities at a given time.

| No. | Business Process | Process Description |
|---|---|---|
| 2.1 | Bill Transaction? | Is a Bill transaction being processed? |
| | | If Yes then go to 2.2 |
| | | If No then go to 2.5 |
| 2.2 | Bill Transaction Date Less Than | Is the Bill transaction date before the last |
| | Last Reconciliation Date? | reconciliation date? |
| | | If Yes then go to END |
| | | If No then go to 2.3 |
| 2.3 | Increment Unbilled by Bill | 2.2 Yes: Unbilled = Unbilled + Bill Transaction |
| | Transaction Amount | Amount |
| 2.4 | Decrement On-Hand by | 2.2 Yes then On-hand = On-hand − Bill Transaction |
| | Transaction Amount | Amount |
| | | 2.6 No then On-hand = On-hand − Use or Dispose |
| | | Transaction Amount |
| | | 2.9 Yes then On-hand = On-hand − Return or |
| | | Transfer-Out Transaction Amount |
| | | Then go to END |
| 2.5 | Used or Disposed Transaction? | Is a Used or Disposed transaction being processed? |
| | | If Yes then go to 2.6 |
| | | If No then go to 2.8 |
| 2.6 | Is Unbilled > 0 | If No go to 2.4 |
| | | If Yes then go to 2.7 |
| 2.7 | Decrement Unbilled by | 2.6 Yes then Unbilled = Unbilled − Use or Dispose |
| | Transaction Amount | Transaction Amount |
| | | 2.9 No & 2.6 Yes then Unbilled = Unbilled − Return or |
| | | Transfer-Out Transaction Amount |
| | | Then go to END |
| 2.8 | Return or Transfer-Out | Is a Return or Transfer-Out Transaction being |
| | Transaction? | processed? |
| | | If Yes then go to 2.9 |
| | | If No then go to 2.10 |
| 2.9 | Is On-hand > 0 | If Yes than go to 2.4 |
| | | If No then go to 2.6 |
| 2.10 | Receive or Transfer-In | Is a Receive or Transfer-In Transaction being |
| | Transaction? | processed? |
| | | If Yes then go to 2.11 |
| | | If No then go to 2.14 |
| 2.11 | Is On Order > 0 | If Yes then go to 2.12 |
| | | If No then go to 2.13 |
| 2.12 | Decrement On Order by | On-order = On-order − Receive or Transfer-in |
| | Transaction Amount | Transaction Amount |
| 2.13 | Increment On-hand by | On-hand = On-hand + Receive or Transfer-in |
| | Transaction Amount | Transaction Amount |
| | | Then go to END |
| 2.14 | Order Transaction? | Is an Order Transaction being processed? |
| | | If Yes then go to 2.15 |
| | | If No then go to 2.16 |
| 2.15 | Increment On-order by | On-order = On-order + Order Transaction Amount |
| | Transaction Amount | Then go to END |
| 2.16 | Set Transaction? | If Yes then go to 2.17 |
| | | If No then go to 2.18 |
| 2.17 | On-hand = Set Transaction | On-hand = Set Transaction Amount |
| | | Then go to END |
| 2.18 | Count Transaction? | If Yes then go To 2.19 |
| | | If No then go to END |
| 2.19 | Set Last Count to Transaction | Last Count = Count Transaction Amount |
| | Amount | |
| 2.20 | Set Last Count Date to | Last Count Date = Count Transaction Date |
| | Transaction Date | |

In FIG. 3, there is Illustrated the Purchase Order Process. There are many different purchase order methods and systems. Purchase Order Process only focuses on the processes that are required for this consignment inventory management and reconciliation system. It does not attempt to go Into details relating to other purchase order systems.

| No. | Business Process | Process Description |
|---|---|---|
| 3.1 | Prepare and Send Purchase | The purchase order process is initiated when the |
| | Order (PO) | buyer sends the seller a purchase order that |
| | | identifies the items, item quantity, item price, and |
| | | other terms and conditions of the purchase. The |
| | | purchase order can be electronic or hardcopy. |
| 3.2 | Extract Consignment Stock from | The buyer can included two types of consignment |
| | Purchase Order | orders on the purchase order: |

| | |
|---|---|
| 2) | Consignment items that have been used. The |
| | buyer is using the purchase order to notify the |
| | seller to transfer ownership of the item to the |
| | buyer. i.e. seller bills/invoices the buyer for the |
| | item. |
| 3) | An order for new/additional consignment items |
| | to be placed by the seller at the buyer's |
| | consignment location. Ownership remains with |
| | the seller until the buyer uses the consignment |
| | items. |

| | | |
|---|---|---|
| | | A common practice in consignment inventory |
| | | management is for the items on the purchase order |
| | | to be treated as both a bill and an order. This allows |
| | | the seller to invoice the buyer and restock the |
| | | consignment item. A contract is usually in place to |
| | | help manage such arrangements. |
| 3.3 | Invoice or Order? | Are the consignment items on the purchase order to |
| | | be billed and/or ordered/restocked? |
| | | If Bill then go to 5.6 Prepare Invoice for Billing - |
| | | see FIG. 5 and its description |
| | | If Order then go to 10.0 Pick Order Process |
| | | Both bill and order are possible in this case |
| 5.6 | Prepare Invoice for Billing | Go To 5.6 - see FIG. 5 and its description |
| 2.0 | Update Consignment Inventory | Go To 2.0 - see FIG. 2 and its description |
| | Process | |
| 10.0 | Pick Order Process | Go To 10.0 - see FIG. 10and its description |

The Restock Process is illustrated in FIG. 4. This is a standard method in the management of consignment inventory. The restock process focuses on the movement of consignment inventory from the seller to the buyer's consignment location. No transfer of ownership takes place. Various approvals and signatures may be required in the process.

| No. | Business Process | Process Description |
|---|---|---|
| 4.1 | Calculate Order Quantity | The order quantity refers to the amount of |
| | | consignment stock that will be moved from the seller |
| | | to the buyer's consignment location. There are many |
| | | different methods available to day to calculate the |
| | | order quantity such as average Usage over a period |
| | | of time or standard deviation based on: |
| | | PAR |
| | | Reorder Point/Safety Stock |
| | | Minimum Order Quantity |
| | | Maximum Order Quantity |
| | | Lead Time |
| | | In addition, the order quantity can be derived from |
| | | the buyer's purchase order or the visual inspection of |
| | | the consignment location by the seller. In all cases |
| | | an agreement between the buyer and seller will |
| | | determine how and when restock orders are |
| | | processed |
| 4.2 | Order > 0 | If Yes then go to 4.3 |
| | | If No then go to END |
| 4.3 | Order Approval Required? | Does the buyer or seller require an approval for |
| | | consignment restocking orders |
| | | If Yes then go to 4.4 |
| | | If No then go to 2.0 |
| 4.4 | Approve Order | There are many standard methods, electronic and |
| | | hardcopy, for approving orders. The order approval |
| | | must be consistent with the agreement between the |
| | | buyer and seller |
| 2.0 | Update Consignment Inventory | Go To 2.0 process order transaction - |
| | Process | see FIG. 2 and its description above. |
| 10.0 | Pick Order Process | Go To 10.0 - see FIG. 10 and its description. |

The Billing Process is illustrated in FIG. 5. This is a standard method in the management of consignment inventory. The billing process initiates the transfer of consignment inventory ownership from the seller to the buyer.

| No. | Business Process | Process Description |
|---|---|---|
| 5.1 | Purchase Order (PO) Required? | Does the contract between the buyer and the seller |
| | | require a purchase order to initiate the billing |
| | | process? |
| | | If Yes then 3.0 - see FIG. 3 and its description |
| | | above. |
| | | If No then 5.2 |
| 3.0 | Purchase Order Process | Go To 3.0 |
| 5.2 | Determine Usage Details | If the buyer has not provided a purchase order then |
| | | the seller must determine what items have been used |
| | | by the buyer. This method is determined by the |
| | | contract between the buyer and the seller. |
| 5.3 | Usage Details | An electronic or hardcopy of the items used is |
| | | created by the seller to initiate the billing process. |
| 5.4 | Approval Required? | Does the buyer require the seller to provide a list of |
| | | the used items to be billed for approval? |
| | | If Yes then go to 5.5 |
| | | If No then go to 5.6 |
| 5.5 | Approve Usage Details | This is a standard method in the management of |
| | | consignment inventory. If the buyer reviews and |
| | | approves, electronic or hardcopy, the usage details |
| | | for billing. |
| 5.6 | Prepare Invoice for Billing | This is a standard method in the management of |
| | | consignment inventory. An electronic or hardcopy |
| | | invoice is prepared. |
| 5.7 | Is 1.7 Transaction = Bill? | Was the process that resulted in the Billing Process |
| | | being executed a Bill Transaction in process 1.7? |
| | | If yes then go to 2.0 Use Transaction - see FIG. 2 |
| | | and its description above. |
| | | If No END |
| 2.0 | Update Consignment Inventory | Go To 2.0 - see FIG. 2 and its description above. |
| | Process | |

FIG. 6 illustrates the Stock Count Process. This is a standard method in the management of consignment inventory. The stocking counting process can take place on a daily, weekly, monthly, and quarterly or on a yearly cycle as well as at any time that the buyer and seller agree to a stock count.

The stock count process (or cycle count as it is sometimes called) consists of taking a physical count of all or a specific group of items at the buyer's consignment location at a time. This may also include counting the lot/batch associated with each item. The lot/batch usually contains the item expiration date and thus the stock count usually includes the identification and removal of expired items.

| No. | Business Process | Process Description |
|---|---|---|
| 6.1 | Count Items | A variety of methods and systems can be used to |
| | | count items including but not limited to an automated |
| | | mobile device that includes a barcode reader. A |
| | | stock count can also be taking using paper and |
| | | pen/pencil. |
| 2.0 | Update Consignment Inventory | Go To 2.0, Count Transaction - see FIG. 2 and its |
| | Process | associated description above. |
| 6.2 | Item Expires? | Is the item being counted expired? A policy may be |
| | | set that requires the identification of not only items |
| | | that have expired but also items that will expire in a |
| | | preset time. |
| | | If Yes go to 7.0 Returns Process - see FIG. 7 and |
| | | its description |
| | | If No go to 8.0 Reconciliation Process - |
| | | see FIG. 8.0 and its description |
| 7.0 | Returns Process | Go To 7.0 - see FIG. 7 and its description |
| 8.0 | Reconciliation Process | Go To 8.0 - see FIG. 7 and its description |

The Returns Process is illustrated in FIG. 7. This is a standard method in the management of consignment inventory. The return process focuses on the movement of consignment inventory from the buyer's consignment location back to the seller. No transfer of ownership takes place. Various approvals and signatures may be required in the process.

An item can be returned for many reasons Including but not limited to an item has expired, is being phased out and the buyer does not want it in the consignment location.

| No. | Business Process | Process Description |
|---|---|---|
| 7.1 | Identify Return Items | A variety of methods and systems can be used to |
| | | record return items including but not limited to and |
| | | automated mobile devices with a barcode reader. A |
| | | return can also be taking using paper and pen/pencil. |
| 2.0 | Update Consignment Inventory | Go To 2.0 Return Transaction - see FIG. 2 and its |
| | Process | description. |
| 7.2 | Return Notification Required? | Does the buyer require a notification, electronic or |
| | | hardcopy, identifying what items have been |
| | | returned? |
| | | If Yes then go to 7.3 |
| | | If No then END |
| 7.3 | Goods Returned Notification | Seller provides the buyer with an electronic or |
| | | hardcopy return notification identifying what items |
| | | have been returned. |
| 7.4 | Return Signature Required? | Does the buyer or seller require the buyer to sign, |
| | | electric or hardcopy, for the returned items? |
| | | If Yes then go to 7.5 |
| | | If No then END |
| 7.5 | Customer Signs Return Form | The customer provides verification usually with a |
| | | signature, electric or hardcopy, that the items on the |
| | | return notification are the items being returned. |
| 7.6 | Signed Goods Returned Form | The seller gets a copy of the signed form |

FIG. 8 illustrates the Reconciliation Process. Current consignment inventory methods and systems refer to the need for a reconciliation process as a method for the buyer and seller to identify what items are missing from the consignment location. Current methods also refer to a need for a contract between the buyer and seller to determine who should bear the costs for the missing items and the need for reports to identify the missing items

The reconciliation process usually follows the Stock Count Process. In current consignment inventory methods and systems, the supplier will then either bill the buyer for the missing items or write off the missing items based on the contract between the buyer and seller. This results in decrementing the On-hand quantity by the missing amount. The missing amount is the different between the count and the On-hand amount. Currently the seller has no way to track the missing items over a period of time.

In addition the count process may find items that are at the buyer's consignment location but the seller has no record of shipping these items. This can happen for a number of reasons including:
an unrecorded transfer from one buyer's consignment location to another. In this case the seller actually owns the item
a non-consignment item is placed and counted with the consignment items. In this case the buyer actually owns the items.

The buyer and the seller have no way of knowing who owns the item and the current systems and methods have no way of tracking these items.

As discussed in relations to FIG. 2, update consignment inventory process, the method and system of the present invention tracks the missing items as Unbilled and the extra items as Excess. This allows the seller to age (track the amounts over time) and research the unbilled and excess to better determine what action to take. Thus providing a more accurate visibility into the consignment inventory.

The reconciliation process adjusts the On-Hand, Unbilled and Excess amounts to accurately reflect what items are actually at the buyer's consignment inventory location at any time.

| No. | Business Process | Process Description |
|---|---|---|
| 8.1 | Select Buyer | The seller identifies which buyer's consignment |
| | | inventory is to be reconciled |
| 8.2 | Select Buyer Location | A buyer may have more than one consignment |
| | | inventory location and the seller identifies which |
| | | consignment inventory location is to be reconciled |
| 8.3 | Select Item Category(s) | The items can be grouped together in any number of |
| | | logical ways and the seller may choose to reconcile a |
| | | set group of items |
| 8.4 | Select Item(s)/Lot(s) to be | The seller can specify specific items and specific lots |
| | reconciled | for an item to be reconciled |
| 8.5 | Count Date Less than | Is the last count date less than the last reconciliation |
| | Reconciliation Date | date? |
| | | If Yes then go to 10.6 - see FIG. 10 and its |
| | | description |
| | | If no then go to 10.7 - see FIG. 10 and its |
| | | description |
| 8.6 | Set Last Count = 0 | This enables a count of 0 for items that are not found |
| | | (counted) at the consignment location. |
| 8.7 | Last Count less than On-Hand? | Is the last count quantity less than the On-hand |
| | | quantity? |
| | | If Yes then 8.8 |
| | | If No then 8.10 |
| 8.8 | Increase Unbilled by On-hand | Unbilled = Unbilled + (On-hand − Count) |
| | minus Count | |
| 8.9 | Decrease On-hand by On-hand | On-hand = On-hand − (On-hand − Count) |
| | minus Count | |
| 8.10 | Last Count Greater than On- | Is the last count quantity greater than the On-hand |
| | hand? | quantity? |
| | | If Yes then go to 8.11 |
| | | If No then END (This means that Count = On-hand |
| | | and no adjustments are required) |
| 8.11 | Increase Excess by Count | Excess = Excess + (Count − On-hand) |
| | minus On-hand | |
| 8.12 | Increase On-hand by Count | On-hand = On-hand + (Count − On-hand) |
| | minus On-hand | |

The Adjust Excess & Unbilled Process is illustrated In FIG. 9. A seller may track items at the lot level. Lots are used to group items together based on when they were manufacture. The Lot also identifies the items expiration date. A seller will track the lots in order to determine exactly where a group of products are located. A seller will also track lots to better manage item expiration date so that consignment Items can be moved to a location where they are more likely to sell before they expire. Lots are used in the manufacturing of most items. Lots are especially important in the healthcare and food industries where products have a short life span, and people's lives may be at risk.

The seller usually knows what lot has been shipped to the buyer's consignment location, but the buyer may not track which lots are used. Thus seller does not know which lots have been used and which lots are still on the shelf.

The current methods and systems require the seller to bill a specific lot if they shipped a specific lot. Since the seller does not know what lot has been used they often bill the wrong lot. This is usually of no concern to the buyer but it can be a problem for the seller since it gives them an inaccurate view of what item/lots are on consignment at the buyer's location

The adjust excess & unbilled process of FIG. 9 uses the information from the reconciliation to net out the excess and unbilled lots for an item. The result is an accurate view of what lots are On-hand, Unbilled and Excess.

| No. | Business Process | Process Description |
|---|---|---|
| 9.1 | Select Buyer | The seller identifies which buyer's consignment |
| | | inventory is to be adjusted |
| 9.2 | Select Buyer Location | A buyer may have more than one consignment |
| | | inventory location and the seller identifies which |
| | | consignment inventory location is to be adjusted |
| 9.3 | Select Item Category(s) | The items can be grouped together in an number of |
| | | logical ways and the seller may choose to adjust a |
| | | specific group of items |
| 9.4 | Select Item(s) to be adjusted | The seller can specify specific items to be adjusted |
| 9.5 | Select Lot(s) to be adjusted | The seller can specify specific lots for an item to be |
| | | adjusted |
| 9.6 | Excess Greater than Zero? | Is the Excess quantity greater than zero? |
| | | If Yes then 9.7 |
| | | If no then END |
| 9.7 | Unbilled Grater than Zero? | Is the Unbilled quantity greater than zero? |
| | | If Yes then 9.8 |
| 9.8 | Excess = Excess minus 1 | Excess = Excess − 1 |
| 9.9 | Unbilled = Unbilled minus 1 | Unbilled = Unbilled − 1, Go to 9.6 |

In FIG. 10 is illustrated the Order Selection Process. Order picking (sometimes called order fulfilment) is the process for matching the buyer's consignment restock order with the seller's stock in a warehouse. The seller then selects the stock from the warehouse to full the buyers restock order. There are many standard methods, electronic and hardcopy, for order selecting.

| No. | Business Process | Process Description |
|---|---|---|
| 10.1 | On Order Items Available? | Is the item(s) available in the sellers warehouse |
| | | If Yes the go to 10.3 |
| | | If not then go to 10.2 |
| 10.2 | Order Item | The seller generates a purchase order the item |
| | | required the buyers consignment inventory location |
| 10.3 | Generate Pick Slip | An electronic or hardcopy notification is generated to |
| | | alert an individual to what items to be selected for |
| | | delivery to the buyers consignment inventory location |
| 2.0 | Update Consignment Inventory | Go to 2.0 - see FIG. 2 and its description. The |
| | Process | picked order quantity will generate a receive |
| | (Receive, Order Transaction) | transaction of the same amount and an order |
| | | transaction of the negative of that amount. |
| 10.4 | Pick Slip | The electronic or hardcopy notification |
| 10.5 | Pick Items | The items are identified and selected for deliver from |
| | | the seller to the buyers consignment location |
| 10.6 | Deliver Items | The items are physically placed at the buyer's |
| | | consignment location. Some from of electronic or |
| | | hardcopy verification may be require upon deliver. |

The consignment inventory management and reconciliation method and system described above tracks and reconciles on-hand quantity which represents consignment items that were placed at the consignment location and are physically located at the consignment location at a given time; unbilled quantity which represents consignment items which were placed at the consignment location and are not physically present at the consignment location and have not been purchased at a given time, excess quantity which represents items found at the consignment location but are not considered consignment items at a given time; and total or perpetual quantity which represents the consignment items which have been delivered to the consignment location at a given time.

The tracking of unbilled and excess consignment quantity provides visibility to the supplier that has not been available before in previous inventory tracking systems and methods. This visibility allows the supplier to accurately manage the consignment inventory items and identify the potential financial exposure (write off) as well as guard against lost sales.

The consignment inventory management and reconciliation method and system work as an enhancement to traditional consignment inventory methods and systems by provided a method and system for processing specific transactions that increase and decrease the on-hand, unbilled and excess quantities. This is accomplished with the update consignment inventory process, reconciliation process and adjust excess & unbilled process.

The present invention also extends to a computer useable medium having a computer program code that is configured to cause a processor to execute one or more functions to perform the process steps described above.

Whilst there has been described in the foregoing description preferred embodiments of the present invention, it will be understood by those skilled in the technology and business systems that many variations or modifications in details of operation may be made without departing from the present invention.

1. A consignment inventory management and reconciliation system wherein there is tracking and reconciliation of:
a. first items shipped to a buyer from a seller and that are located at the buyer's consignment inventory location;
b. second items shipped to the buyer by the seller, that have not been billed by the seller and cannot be found at the buyer's consignment inventory location; and
d. third items not shipped to the buyer by the seller, can be found at the buyer's consignment inventory location, and are of the same identity as items provided on consignment by the seller to the buyer.

2. A system as claimed in claim 1, wherein the system also ages the first items, the second items, and the third items;

3. A system as claimed in claim 1, wherein there is tracking of one or more selected from the groups consisting of: item number, item lot number, and item expiry date.

4. A system as claimed in claim 3, wherein tracking takes place whenever a transaction is processed.

5. A system as claimed in claim 3, wherein the transaction is represented by a transaction description and a transaction amount.

6. A system as claimed in claim 5, wherein the transaction amount can be one: zero, a positive number, and a negative number, with a number of decimal places.

7. A system as claimed in claim 4, wherein the transaction is one or more selected from the group consisting of: bill, use, dispose, return, transfer-out, receive, transfer-in, order, set, and current.

8. A system as claimed in claim 7, wherein bill is used when the item is no longer at the buyer's consignment location but ownership has not been transferred from the seller to the buyer.

9. A system as claimed in claim 7, wherein use is used when the buyer has used the item and the process of transferring ownership from the seller to the buyer should be initiated or has been competed.

10. A system as claimed in claim 7, wherein dispose in used when the item is no longer at the buyer's consignment location and seller is writing off the item; ownership will not be transferred from the seller to the buyer.

11. A system as claimed in claim 7, wherein receive is used when the item is physically being moved from the seller to the buyer's consignment location; ownership will not be transferred from the seller to the buyer.

12. A system as claimed in claim 7, wherein transfer-in is used when the item is physically being moved to the buyers consignment location from a third party location; ownership will not be transferred from the seller to the buyer.

13. A system as claimed in claim 7, wherein return in used when the item is physically being moved from the buyer's consignment location back to the seller; ownership will not be transferred from the seller to the buyer.

14. A system as claimed in claim 7, wherein transfer-out is used when the item is physically being moved from the buyer's consignment location to a third party location; ownership will not be transferred from the seller to the buyer.

15. A system as claimed in claim 7, wherein order is used when a result has been made to increase the buyer's consignment item(s) quantity.

16. A system as claimed in claim 7, wherein set is used when the quantity of items that the seller and the buyer agree is at the consignment location and is used as a starting point for consignment inventory On-hand quantity.

17. A system as claimed in claim 7, wherein count is used when the quantity can be physically found and verified by the seller and buyer at the buyer's consignment location at a time.

18. A system as claimed in claim 1, wherein reconciliation takes place after a stock count process.

19. A system as claimed in claim 18, wherein the reconciliation notes the second items as Unbilled and the third items as Excess to enable the seller to track quantities of second items and third items over time to provide a more accurate history of consignment inventory.

20. A system as claimed in claim 3, wherein the seller uses the tracking of the item lot number and item expiry date to determine which of the first and second items are approaching an expiry date and thus need to be adjusted.

21. A system as claimed in claim 1, wherein the first items are grouped together in a plurality of categories.

22. A system as claimed in claim 1, wherein the second items are grouped together in a plurality of categories.

23. A system as claimed in claim 1, wherein the third items are grouped together in a plurality of categories.

24. A system as claimed in claim 21, wherein adjustment is according to one or more of the plurality of categories.

25. A system as claimed in claim 1, wherein an inventory total is the sum of the first items and the second items, less the third items.

26. A consignment inventory management and reconciliation system wherein there is tracking and reconciliation of:
(a) first items shipped to a buyer from a seller and that are located at the buyer's consignment inventory location; and
(b) second items shipped to the buyer by the seller that have not been billed by the seller and cannot be found at the buyer's consignment inventory location.

27. A system as claimed in claim 26, wherein there is also tracking and reconciliation of third items not shipped to the buyer by the seller, that can be found at the buyer's consignment inventory location, and are of the same identity as items provided on consignment by the seller to the buyer.

28. A consignment inventory management and reconciliation system wherein there is tracking and reconciliation of:
(a) first items shipped to a buyer from a seller and that are located at the buyers consignment inventory location; and
(b) third items not shipped to the buyer by the seller, that can be found at the buyer's consignment inventory location, and are of the same identity as items provided on consignment by the seller to the buyer.

29. A system as claimed in claim 28, wherein there is also tracking and reconciliation of second items shipped to the buyer by the seller, that have not been billed by the seller and cannot be found at the buyer's consignment inventory location.

30. A consignment inventory management and reconciliation system wherein there is tracking and reconciliation of:
(a) second items shipped to the buyer by the seller, that have not been billed by the seller and cannot be found at the buyer's consignment inventory location; and
(b) third items not shipped to the buyer by the seller, can be found at the buyer's consignment inventory location, and are of the same identity as items provided on consignment by the seller to the buyer.

31. A computer useable medium having a computer program code that is configured to cause a processor to execute one or more functions to perform the process steps as defined in claim 1.
